(19) United States
(12) Patent Application Publication
(10) Pub. No.: US 2012/0241094 A1
(43) Pub. Date: Sep. 27, 2012

(54) SPOT GLUING DEVICE

(75) Inventors: TENG-TSUNG HUANG, Tu-Cheng (TW); YONG-BING HU, Shenzhen City (CN); GONG-SHUI CHENG, Shenzhen City (CN)

(73) Assignees: HON HAI PRICISION INDUSTRY CO., LTD., Tu-Cheng (TW); HONG FU JIN PRECISION INDUSTRY (ShenZhen) CO., LTD, Shenzhen City (CN)

(21) Appl. No.: 13/207,161

(22) Filed: Aug. 10, 2011

(30) Foreign Application Priority Data
Mar. 22, 2011 (CN) 201110069227.8

(51) Int. Cl. B32B 37/12

(52) U.S. Cl. 156/378; 156/349

(57) ABSTRACT

A spot gluing device includes a base for controlling the spot gluing device; a work plate movably mounted to the base in a first longitudinal direction; a support mounted to the base above the work plate; a first driving device movably mounted to the support frame; a second driving device mounted to the support and connected to the first driving device, the second driving device driving the first driving device to move relative to the work plate in a second longitudinal direction perpendicular to the first longitudinal direction; and a gluing assembly mounted to the first driving device facing the work plate. The first driving device drives the gluing assembly to move in a third longitudinal direction perpendicular to the first longitudinal direction and the second longitudinal direction.

### BACKGROUND

1. Technical Field

This disclosure relates to spot gluing devices, particularly to spot gluing devices for gluing parts of an electronic device.

2. Description of Related Art

Typically, many components of electronic devices may be fixed together by spot gluing method using a spot gluing machine. The spot gluing machine includes a work plate for retaining workpieces that needs to be spot glued, and a glue gun for applying glue on the workpieces after the glue gun is aligned with the workpieces. However, the conventional way to do this manually aligns the workpieces and the glue gun, which is difficult to execute precisely each time.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary spot gluing device. Moreover, in the drawings like reference numerals designate corresponding parts throughout the several views. Wherever possible, the same reference numbers are used throughout the drawings to refer to the same or like elements of an embodiment.

FIG. 1 is a schematic view of an exemplary embodiment of a spot gluing device.

FIG. 2 is similar to the FIG. 1, but a first driving device is partially exploded.

FIG. 3 is similar to the FIG. 1, but a second driving device is partially exploded.

FIG. 4 is similar to the FIG. 1, but a third driving device is partially exploded.

FIG. 5 is a partially enlarged view of a gluing assembly of FIG. 1.

### DETAILED DESCRIPTION

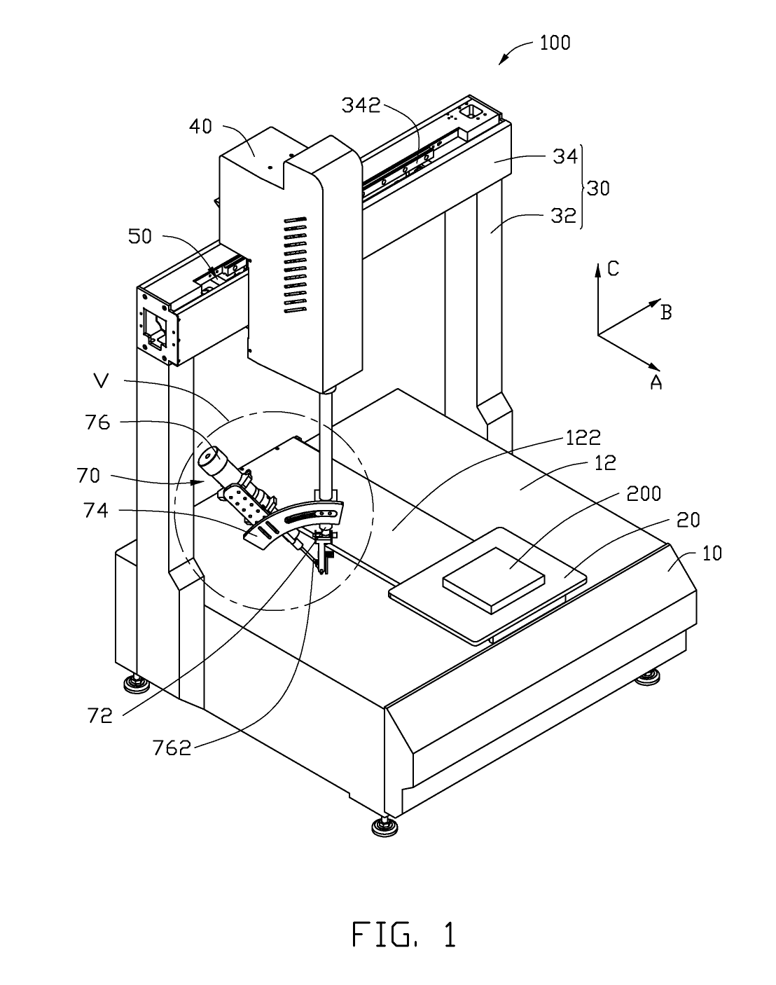

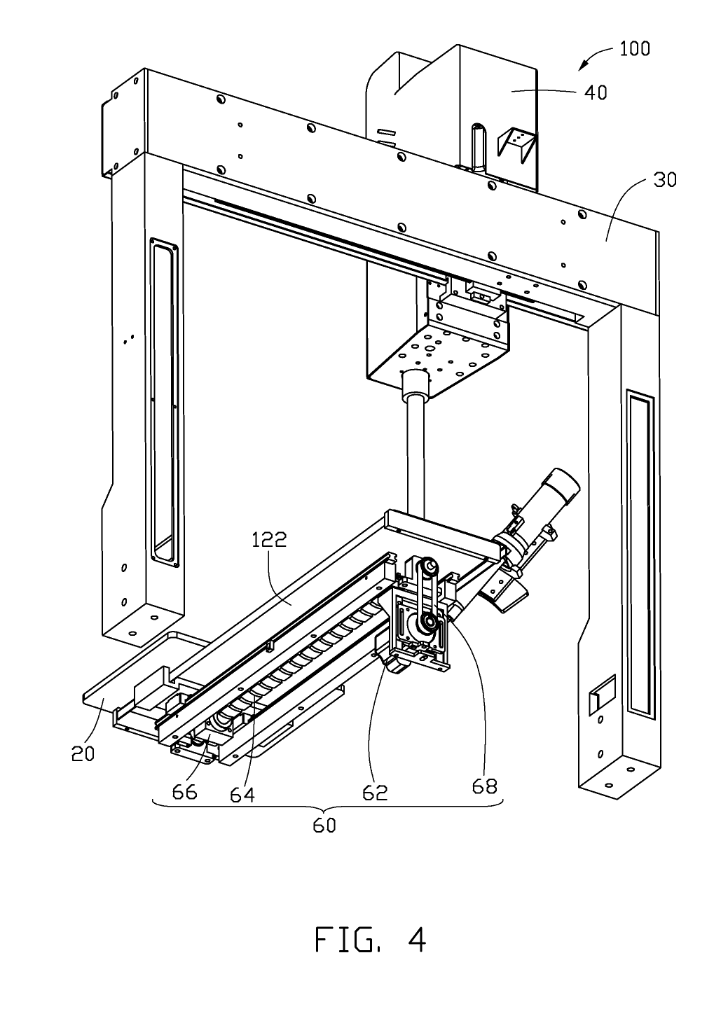

Referring to FIGS. 1-3, an exemplary embodiment of a spot gluing device 100 is used to glue a workpiece 200. The spot gluing device 100 includes a base 10, a work plate 20 movably mounted to and with respect to the base 10, a support frame 30 mounted to the base 10 above the work plate 20, a first driving device 40 slidably mounted to the support frame 30, a second driving device 50 non-slidably mounted to the support frame 30, a third driving device 60 (FIG. 4) mounted in the base 10, and a gluing assembly 70 mounted to the first driving device 40 facing the work plate 20.

The base 10 includes a top board 12, and a first guiding rail 122 located on the top board 12 and extending along first longitudinal direction A. The work plate 20 is slidably mounted to the first guiding rail 122.

The support frame 30 includes two parallel uprights 32 respectively located on opposite sides of the base 10, and a connecting rod 34 connecting the uprights 32 and above the base 10. The connecting rod 34 has a second guiding rail 342 located thereon and extending along second longitudinal direction B perpendicular to the first longitudinal direction A.

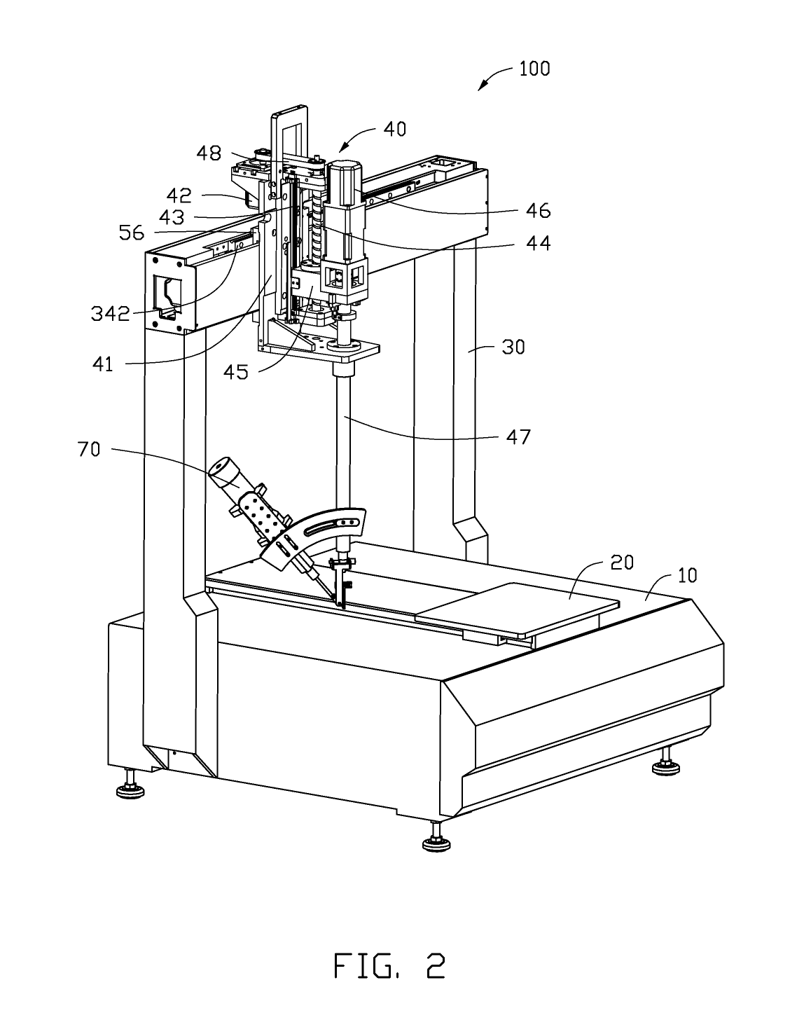

Referring to FIG. 2, the first driving device 40 includes a retaining board 41, a first motor 42 mounted to the retaining board 41, a third guiding rail 43 mounted to the retaining board 41 and extending along third longitudinal direction C perpendicular to the first longitudinal direction A and the second longitudinal direction B, a first threaded rod 44 rotatably connected to the first motor 42, a first movable element 45 screwed on the first threaded rod 44 and movably mounted to the third guiding rail 43, a rotation motor 46 retained to the first movable element 45 and a shaft 47 linked to the rotation motor 46. The first threaded rod 44 is connected to the first motor 42 by a belt 48. The first motor 42 drives the first threaded rod 44 to rotate relative to the retaining board 41, causing the first movable element 45 moving along the third guiding rail 43 in the third longitudinal direction C to drive the rotation motor 46 and the shaft 47 to move in the third longitudinal direction C. The rotation motor 46 is used to drive the shaft 47 to rotate.

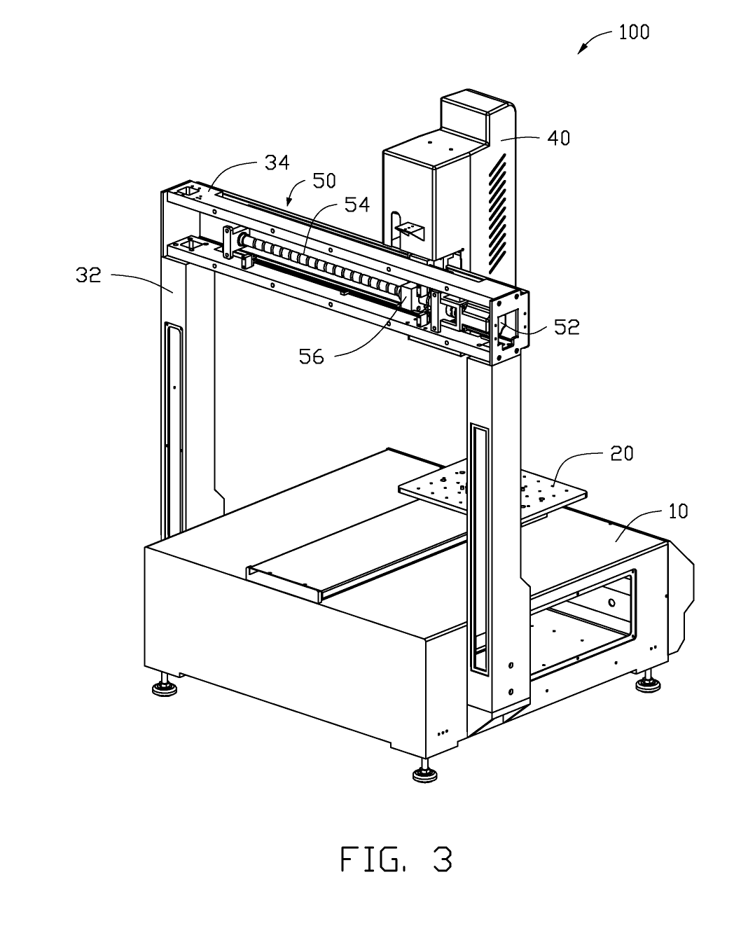

Referring to FIGS. 2 and 3, the second driving device 50 includes a second motor 52 retained to the connecting rod 34, a second threaded rod 54 connected on the second motor 52, and a second movable element 56 screwed on the second threaded rod 54 and movably mounted to the second guiding rail 342. The second movable element 56 is further retained to the retaining board 41. The second motor 52 drives the second threaded rod 54 to rotate causing the second movable element 56 to move the second guiding rail 342 so the first driving device 40 moves in the second longitudinal direction B.

Referring to FIG. 4, the third driving device 60 is used to drive the work plate 20 to move relative to the base 10 along the first guiding rail 122. The third driving device 60 includes a third motor 62 located in the base 10, a third threaded rod 64 rotatably mounted to the base 10, a third movable element 66 screwed on the third threaded rod 64 and movably mounted to the first guiding rail 122, a belt 68 connecting the third motor 62 with the third threaded rod 64. The third movable element 66 is retained to the work plate 20. The third motor 62 drive the third threaded rod 64 to rotate causing the third movable element 66 to move along the first guiding rail 122 so the work plate 20 moves in the first longitudinal direction A.

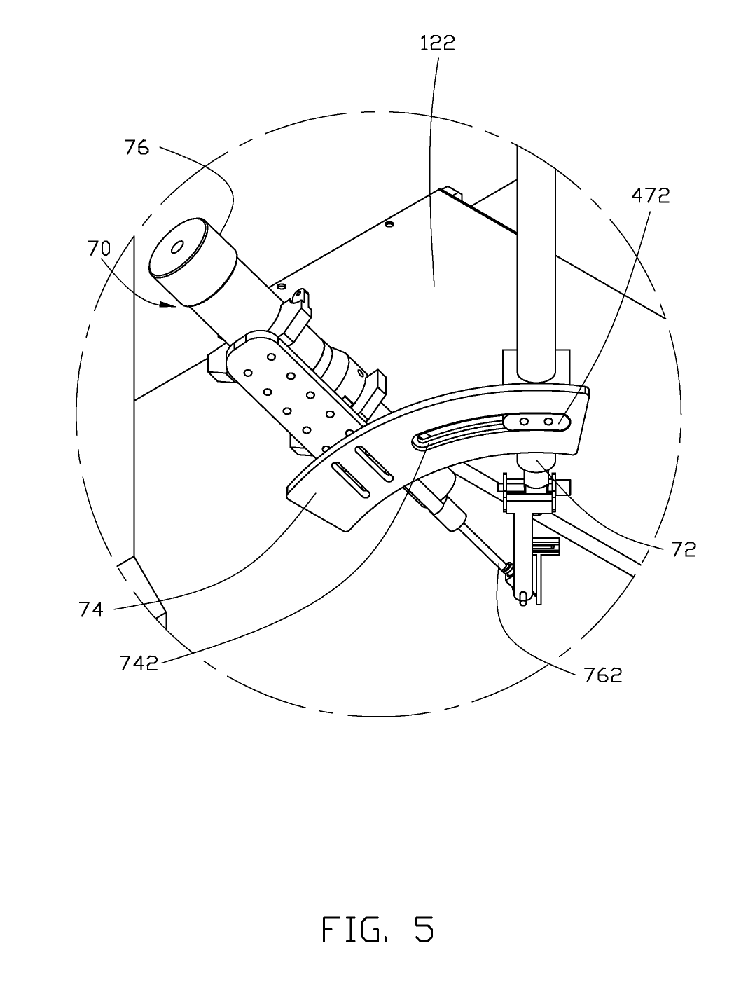

Referring to FIG. 1, the gluing assembly 70 includes a laser pen 72 mounted to a distal end of the shaft 47, a direction adjusting board 74 adjustably mounted to the shaft 47 and a glue gun 76 mounted to the direction adjusting board 74. The glue gun 76 includes a glue tube 762. Referring to FIG. 5, the direction adjusting board 74 defines a track 742 and the shaft has a rail 472. The rail 472 slidably engages the track 742 so the direction adjusting board 74 can slide relative to the shaft 47 to adjust the longitudinal direction of the glue tube 762. The laser pen 72 is used to give a visual indication of whether the longitudinal axis of the glue tube 762 intersects with the longitudinal axis of the shaft 47.

Referring to FIG. 1-3, in use, the workpiece 200 is retained to the work plate 20. The longitudinal axis of the glue tube 762 is adjusted to intersect with the longitudinal axis of the shaft 47, as indicated by the laser pen 72. The third motor 62 starts to drive the third threaded rod 64 to rotate via belt 68. Because the third movable element 66 is stationarily mounted to the first guiding rail 122, the third movable element 66 cannot rotate with the third threaded rod 64, but can move along the longitudinal axis of the third threaded rod 64 to drive the work plate 20 to move in the first longitudinal direction A until the workpiece 200 moves to a predetermined position in the first longitudinal direction A. The predetermined position typically will be the line going through the A axis coordinate of the gluing spot. The second motor 52 starts. Because the second movable element 56 is limited by the second guiding rail 342, the second movable element 56 cannot rotate with the second threaded rod 54, but can move along the longitudinal axis of the second threaded rod 54 to drive the first driving device 40 to move in the second longitudinal direction B, until the glue tube 762 moves to a predetermined position in the second longitudinal direction B. The predetermined position typically will be the line going through the B axis coordinate of the gluing spot. Finally, the first motor 42 starts. Because the first movable element 45 is limited by the third guiding rail 43 so the first movable element 45 cannot rotate with the first threaded rod 44, but can move along the first threaded rod 44 to drive the gluing assembly 70 to move in the third longitudinal direction C, until the glue tube 762 moves to a predetermined position in the third longitudinal direction C. The predetermined position typically will be the line going through the C axis coordinate of the gluing spot. Accordingly, the glue tube 762 is located near the gluing spot of the workpiece 200. The rotation motor 46 starts to drive the glue gun 76 to rotate about the longitudinal direction C axis, and the glue gun 76 starts to glue the gluing spot of the workpiece 200. It is to be understood that the second or third motor 62 can be started again to glue other gluing spots of the workpiece if necessary. Furthermore, through electronic control, the sequencing of motor activation can be changed or made virtually simultaneous.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A spot gluing device, comprising:
a base;
a work plate movably mounted in a first longitudinal direction to the base;
a support frame mounted to the base above the work plate;
a first driving device movably mounted to the support frame;
a second driving device mounted to the support frame and connected to the first driving device, the second driving device driving the first driving device to move relative to the work plate in a second longitudinal direction perpendicular to the first longitudinal direction; and
a gluing assembly mounted to the first driving device and facing the work plate;
wherein the first driving device drives the gluing assembly to move in a third longitudinal direction perpendicular to the first longitudinal direction and the second longitudinal direction.

2. The spot gluing device of claim 1, wherein the first driving device includes a retaining board, a first motor mounted to the retaining board, a third guiding rail mounted to the retaining board and extending along the third longitudinal direction, a first threaded rod is rotatably connected to the first motor, the first motor drives the first threaded rod to rotate, a first movable element is screwed on the first threaded rod and movably mounted to the third guiding rail.

3. The spot gluing device of claim 2, further comprising a rotation motor retained to the first movable element and connecting to the gluing assembly by a shaft parallel to the third longitudinal direction, the rotation motor driving the gluing assembly to rotate about the longitudinal axis of the shaft.

4. The spot gluing device of claim 3, wherein the gluing assembly comprises a glue gun with a glue tube, and a laser pen retained to the shaft; the laser pen used to give a visual indication of whether the longitudinal axis of the glue tube intersects with the longitudinal axis of the shaft.

5. The spot gluing device of claim 4, wherein the gluing assembly further comprises a direction adjusting board retained to the shaft, the glue gun is located on the direction adjusting board, the direction adjusting board adjusts a longitudinal direction of the glue tube.

6. The spot gluing device of claim 1, wherein the support frame comprises two uprights and a connecting rod connecting the uprights, the second driving device is mounted to the connecting rod.

7. The spot gluing device of claim 6, wherein the connecting rod has a second guiding rail located thereon and extending along the second longitudinal direction, the second driving device movably mounted to the second guiding rail.

8. The spot gluing device of claim 7, wherein the second driving device includes a second motor retained to the connecting rod, a second threaded rod connected on the second motor, and a second movable element screwed on the second threaded rod and movably mounted to the second guiding rail; the second motor drives the second threaded rod to rotate causing the second movable element moving along the second guiding rail so the first driving device moves in the second longitudinal direction.

9. The spot gluing device of claim 1, further comprising a third driving device located in the base, the third driving device driving the work plate to move relative to the base in the first longitudinal direction.

10. The spot gluing device of claim 1, wherein the base has a first guiding rail located thereon and extending along the first longitudinal direction, the third driving device includes a third motor located in the base, a third threaded rod rotatably mounted to the base, a third movable element screwed on the third threaded rod and movably mounted to the first guiding rail; the third movable element is retained to the work plate; the third motor drive the third threaded rod to rotate causing the third movable element moving along the first guiding rail so the work plate moves in the first longitudinal direction.

11. A spot gluing device, comprising:
a base;
a work plate movably mounted to the base in a first longitudinal direction;
a support frame mounted to the base above the work plate;
a first driving device movably mounted to the support frame;
a second driving device driving the first driving device to move relative to the work plate in a second longitudinal direction perpendicular to the first longitudinal direction; and
a gluing assembly mounted to the first driving device and located between the work plate and the first driving device;
wherein the first driving device drives the gluing assembly to move in a third longitudinal direction perpendicular to the first longitudinal direction and the second longitudinal direction.

12. The spot gluing device of claim 11, wherein the first driving device includes a retaining board, a first motor mounted to the retaining board, a third guiding rail mounted to the retaining board and extending along the third longitudinal direction, a first threaded rod is rotatably connected to the first motor, the first motor drives the first threaded rod to rotate, a first movable element is screwed on the first threaded rod and movably mounted to the third guiding rail.

13. The spot gluing device of claim 12, further comprising a rotation motor retained to the first movable element and connecting to the gluing assembly by a shaft parallel to the third longitudinal direction, the rotation motor driving the gluing assembly to rotate around the shaft.

14. The spot gluing device of claim 13, wherein the gluing assembly comprises a glue gun with a glue tube, and a laser pen retained to the shaft; the laser pen used to give a visual indication of whether the longitudinal axis of the glue tube intersects with the longitudinal axis of the shaft.

15. The spot gluing device of claim 14, wherein the gluing assembly further comprises a direction adjusting board retained to the shaft, the glue gun is located on the longitudinal direction adjusting board, the direction adjusting board adjusts a longitudinal direction of the glue tube.

16. The spot gluing device of claim 11, wherein the support frame comprises two uprights and a connecting rod connecting the uprights, the second driving device is mounted to the connecting rod.

17. The spot gluing device of claim 16, wherein the connecting rod has a second guiding rail located thereon and extending along the second longitudinal direction, the second driving device movably mounted to the second guiding rail.

18. The spot gluing device of claim 17, wherein the second driving device includes a second motor retained to the connecting rod, a second threaded rod connected on the second motor, and a second movable element screwed on the second threaded rod and movably mounted to the second guiding rail; the second motor drives the second threaded rod to rotate causing the second movable element moving along the second guiding rail so the first driving device moves in the second longitudinal direction.

19. The spot gluing device of claim 11, further comprising a third driving device located in the base, the third driving device driving the work plate to move relative to the base in the first longitudinal direction.

20. The spot gluing device of claim 11, wherein the base has a first guiding rail located thereon and extending along the first longitudinal direction, the third driving device includes a third motor located in the base, a third threaded rod rotatably mounted to the base, a third movable element screwed on the third threaded rod and movably mounted to the first guiding rail; the third movable element is retained to the work plate; the third motor drive the third threaded rod to rotate causing the third movable element moving along the first guiding rail so the work plate moves in the first longitudinal direction.
